(19) United States
(12) Patent Application Publication
(10) Pub. No.: US 2013/0077820 A1
(43) Pub. Date: Mar. 28, 2013

(54) MACHINE LEARNING GESTURE DETECTION

(71) Applicants: Charles Claudius Marais, Duvall, WA (US); Zsolt Mathe, Redmond, WA (US); Mark Seminatore, Issaquah, WA (US); Ivan Nevraev, Reading (GB)

(72) Inventors: Charles Claudius Marais, Duvall, WA (US); Zsolt Mathe, Redmond, WA (US); Mark Seminatore, Issaquah, WA (US); Ivan Nevraev, Reading (GB)

(73) Assignee: MICROSOFT CORPORATION, Redmond, WA (US)

(21) Appl. No.: 13/245,640

(22) Filed: Sep. 26, 2011

(51) Int. Cl. G06K 9/62

(52) U.S. Cl. 382/103

(57) ABSTRACT

A virtual skeleton includes a plurality of joints and provides a machine readable representation of a human subject observed with a sensor such as a depth camera. A gesture detection module is trained via machine learning to identify one or more features of a virtual skeleton and indicate if the feature(s) collectively indicate a particular gesture.

### BACKGROUND

A gesture is a pose, action, or motion that communicates the intent of a human. Gesture detection is the ability of a computer to recognize a human gesture. In this context, gesture detection includes analyzing a human subject's full or partial body while the body is moving or static to determine whether or not a particular gesture is being performed. A binary determination and related confidence can be made for each of one or more different possible gestures—e.g., PlayerIsKicking (85% confident).

Some gesture detection systems include one or more sensors that are used to observe a human subject. For example, a gesture detection system may include a depth camera, a visible light camera, and/or other sensors. Furthermore, a gesture detection system may include a processing module configured to analyze data from the sensors and generate a virtual skeleton that models a pose of the human subject.

Even when a human subject can be perfectly modeled with a virtual skeleton, it remains a difficult challenge to determine whether or not the human subject is intending to perform a particular gesture.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of the disclosure, a gesture detection module is trained to determine if a gesture model, such as a virtual skeleton modeling a human subject, has performed a particular gesture. The gesture detection module is trained via machine learning to identify one or more features of the gesture model and indicate if the feature(s) collectively indicate the particular gesture.

### BRIEF DESCRIPTION OF THE DRAWINGS

FIG. 1 shows a depth-image analysis system viewing an observed scene in accordance with an embodiment of the present disclosure.

FIG. 2 shows a simplified skeletal modeling pipeline in accordance with an embodiment of the present disclosure.

FIG. 3 schematically shows a gesture detection module being trained according to an embodiment of the present disclosure.

FIG. 4 schematically shows the gesture detection module of FIG. 3 in use after training according to an embodiment of the present disclosure.

FIG. 5 schematically shows a computing system that may execute a gesture detection module in accordance with an embodiment of the present disclosure.

### DETAILED DESCRIPTION

The herein disclosed gesture detection system uses machine learning to recognize human gestures. One or more machine learning modules are trained to recognize complex patterns in example observation data. Once sufficiently trained, the machine learning modules can be used to interpret previously unseen observation data and determine if such observation data corresponds to a particular gesture. While primarily described below with reference to depth camera analysis of full body gestures, different types of user gestures may be detected via a variety of different platforms without departing from the scope of this disclosure. As nonlimiting examples, the methodology described below can be used to detect finger gestures on a touch screen, hand gestures via a visible light camera, or game-controller gestures via motion analysis using accelerometers, gyroscopes, and/or camera tracking.

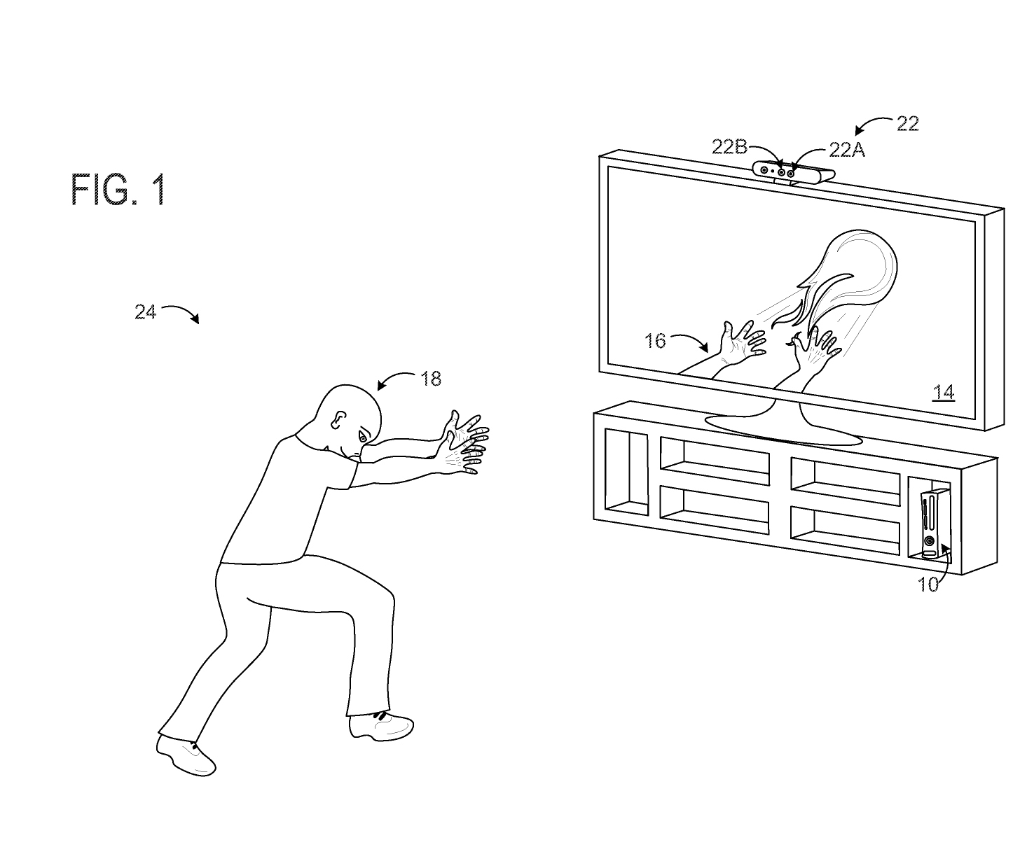

FIG. 1 shows a non-limiting example of a computing system 10 that is configured to detect human gestures. Computing system 10 may be used to play a variety of different games, play one or more different media types, and/or control or manipulate non-game applications and/or operating systems. A display device 14 operatively connected to computing system 10 is shown presenting game visuals 16 to human game player 18.

The computing system 10 may include a sensor input to receive observation information from one or more sensors. As a non-limiting example, the computing system may include a universal serial bus configured to receive depth images and/or color images from one or more input devices including a depth camera and/or a visible light camera. FIG. 1 shows the computing system 10 operatively connected to an input device 22 including a depth camera 22A and a visible light camera 22B.

Game player 18 is tracked by depth camera 22A so that the movements of game player 18 may be interpreted by computing system 10 as controls that can be used to affect the game being executed by computing system 10. In other words, game player 18 may use his or her physical movements to control the game without a conventional hand-held game controller or other hand-held position trackers. For example, in FIG. 1 game player 18 is performing a spell throwing gesture to cast a fireball spell at game enemies. The movements of game player 18 may be interpreted as virtually any type of control. Some movements of game player 18 may be interpreted as player character controls to control the actions of the game player's in-game player character. Some movements of game player 18 may be interpreted as controls that serve purposes other than controlling an in-game player character. As a non-limiting example, movements of game player 18 may be interpreted as game management controls, such as controls for selecting a character, pausing the game, or saving game progress.

Depth camera 22A may also be used to interpret target movements and/or static poses as operating system and/or application controls that are outside the realm of gaming. Virtually any controllable aspect of an operating system and/or application may be controlled by static and/or dynamic gestures of game player 18. The illustrated scenario in FIG. 1 is provided as an example, but is not meant to be limiting in any way. To the contrary, the illustrated scenario is intended to demonstrate a general concept, which may be applied to a variety of different applications without departing from the scope of this disclosure. As such, it should be understood that while the human controlling the computer is referred to as a game player, the present disclosure applies to non-game applications.

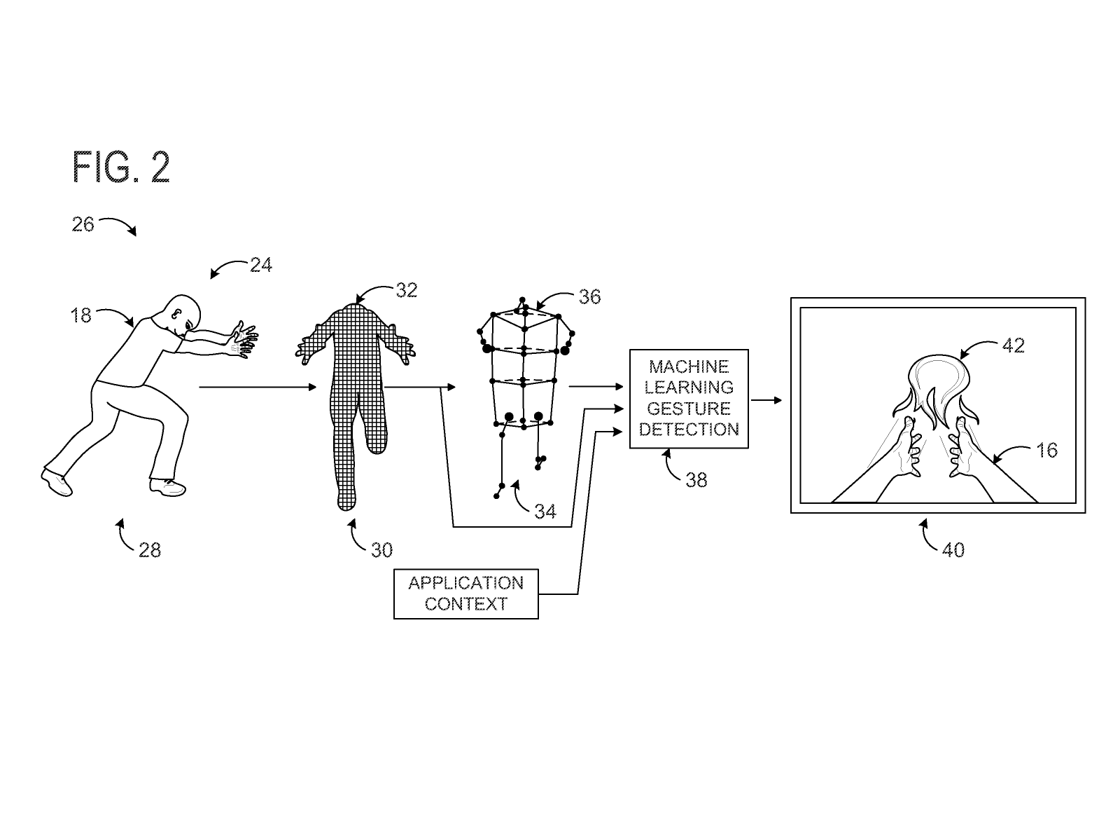

FIG. 2 shows a simplified processing pipeline 26 in which game player 18 in observed scene 24 is modeled as a virtual skeleton 36 that can serve as a control input for controlling various aspects of a game, application, and/or operating system. FIG. 2 shows five stages of the processing pipeline 26: image collection 28, depth mapping 30, skeletal modeling 34, gesture detection 38, and game output 40. It will be appreciated that a processing pipeline may include additional steps and/or alternative steps than those depicted in FIG. 2 without departing from the scope of this disclosure.

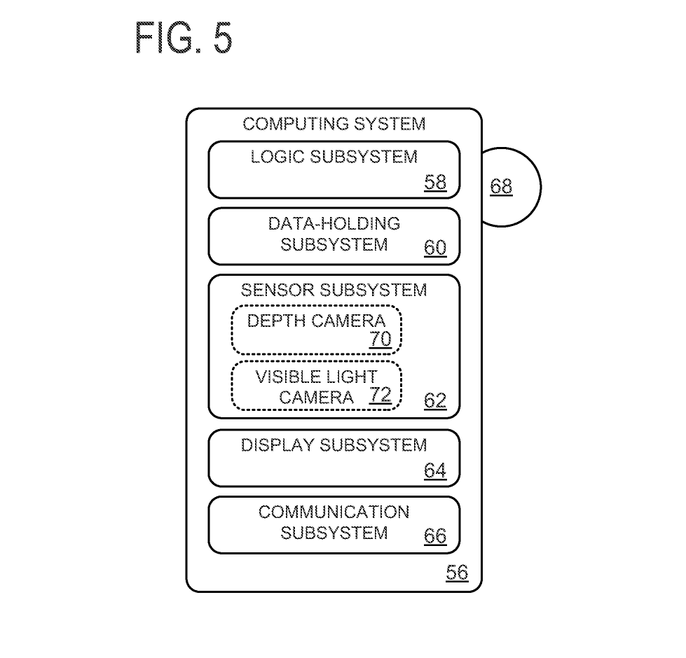

During image collection 28, game player 18 and the rest of observed scene 24 may be imaged by a depth camera 22A. In particular, the depth camera is used to observe gestures of the game player. During image collection 28, the depth camera may determine, for each pixel, the depth of a surface in the observed scene relative to the depth camera. Virtually any depth finding technology may be used without departing from the scope of this disclosure. Example depth finding technologies are discussed in more detail with reference to FIG. 5.

During depth mapping 30, the depth information determined for each pixel may be used to generate a depth map 32. Such a depth map may take the form of virtually any suitable data structure, including but not limited to a depth image buffer that includes a depth value for each pixel of the observed scene. In FIG. 2, depth map 32 is schematically illustrated as a pixelated grid of the silhouette of game player 18. This illustration is for simplicity of understanding, not technical accuracy. It is to be understood that a depth map generally includes depth information for all pixels, not just pixels that image the game player 18. Depth mapping may be performed by the depth camera or the computing system, or the depth camera and the computing system may cooperate to perform the depth mapping.

During skeletal modeling 34, one or more depth images (e.g., depth map 32) of a world space scene including a computer user (e.g., game player 18) are obtained from the depth camera. Virtual skeleton 36 may be derived from depth map 32 to provide a machine readable representation of game player 18. In other words, virtual skeleton 36 is derived from depth map 32 to model game player 18. The virtual skeleton 36 may be derived from the depth map in any suitable manner. In some embodiments, one or more skeletal fitting algorithms may be applied to the depth map. For example, a prior trained collection of models may be used to label each pixel from the depth map as belonging to a particular body part, and virtual skeleton 36 may be fit to the labeled body parts. The present disclosure is compatible with virtually any skeletal modeling technique. In some embodiments, machine learning may be used to derive the virtual skeleton from the depth images.

The virtual skeleton provides a machine readable representation of game player 18 as observed by depth camera 22A. The virtual skeleton 36 may include a plurality of joints, each joint corresponding to a portion of the game player. Virtual skeletons in accordance with the present disclosure may include virtually any number of joints, each of which can be associated with virtually any number of parameters (e.g., three dimensional joint position, joint rotation, body posture of corresponding body part (e.g., hand open, hand closed, etc.) etc.). It is to be understood that a virtual skeleton may take the form of a data structure including one or more parameters for each of a plurality of skeletal joints (e.g., a joint matrix including an x position, a y position, a z position, and a rotation for each joint). In some embodiments, other types of virtual skeletons may be used (e.g., a wireframe, a set of shape primitives, etc.).

Skeletal modeling may be performed by the computing system. In particular, a skeletal modeling module may be used to derive a virtual skeleton from the observation information (e.g., depth map 32) received from the one or more sensors (e.g., depth camera 22A of FIG. 1). In some embodiments, the computing system may include a dedicated skeletal modeling module that can be used by a variety of different applications. In this way, each application does not have to independently interpret depth maps as machine readable skeletons. Instead, the individual applications can receive the virtual skeletons in an anticipated data format from the dedicated skeletal modeling module (e.g., via an application programming interface or API). In some embodiments, the dedicated skeletal modeling module may be a remote modeler accessible via a network. In some embodiments, an application may itself perform skeletal modeling.

The above described virtual skeleton is provided as a nonlimiting example of a gesture model. Virtual skeletons are well suited for modeling the full-body posture and/or movements of a human subject. Other aspects of a human subject may be modeled with other types of gesture models without departing from the scope of this disclosure. As a nonlimiting example, touch patches measured by a touch pad or touch screen may model a user's finger gestures when performing touch inputs. As another example, a color image may model a user's fingers/hands when performing hand gestures.

As introduced above, even if a human subject is perfectly modeled with a virtual skeleton or other gesture model, it remains a difficult challenge to determine if a human subject is performing any particular gesture. For example, it may be difficult to accurately detect gestures by writing particular detection algorithms in the form of executable code for each different gesture. A very large number of input parameters, threshold values, and weights must be tuned and understood for such manually coded gesture detection algorithms to work reliably for a wide variety of different people in a wide variety of different environments. Manually fine tuning the large number of input parameters, thresholds, and weights can be extremely time consuming and frustrating. Furthermore, maintaining the code can be very cumbersome. For example, in the case of a gesture model in the form of a virtual skeleton, if any of the characteristics of the skeletal data provided by the skeleton modeler change (e.g., changing the number of joints of a virtual skeleton, how those joints are tracked, how those joints behave when occluded, and/or the type and amount of noise present on the joints) then all input parameters, thresholds, and weights must again be recognized, understood, and manually tuned for each different gesture. In many cases, the entire gesture detection algorithm may need to be rewritten. If manually coded algorithms are not working well for a particular type of human subject (e.g., small child or heavy adult) and/or a particular type of environment, the algorithm must be recoded manually. Furthermore, manually coded algorithms typically rely on some history of previous frames to detect a gesture, thus introducing latency.

These challenges can be overcome by using machine learning to detect gestures, as indicated at 38. As used herein, machine learning is used to refer to artificial intelligence programming that configures a computer to recognize complex patterns in data. As described in more detail below, a gesture detection module trained via machine learning can be used to accurately assess whether or not a human subject is performing a particular static or dynamic gesture.

During game output 40, the physical movements of game player 18 as recognized via skeletal modeling 34 and/or gesture detection 38 are used to control aspects of a game, application, or operating system. In the illustrated scenario, game player 18 is playing a fantasy themed game and has performed a spell throwing gesture. The machine learning gesture detection recognizes the gesture, and displays an image of the hands of a player character 16 throwing a fireball 42. In some embodiments, an application may leverage various graphics hardware and/or graphics software to render an interactive interface (e.g., a spell-casting game) for display on a display device.

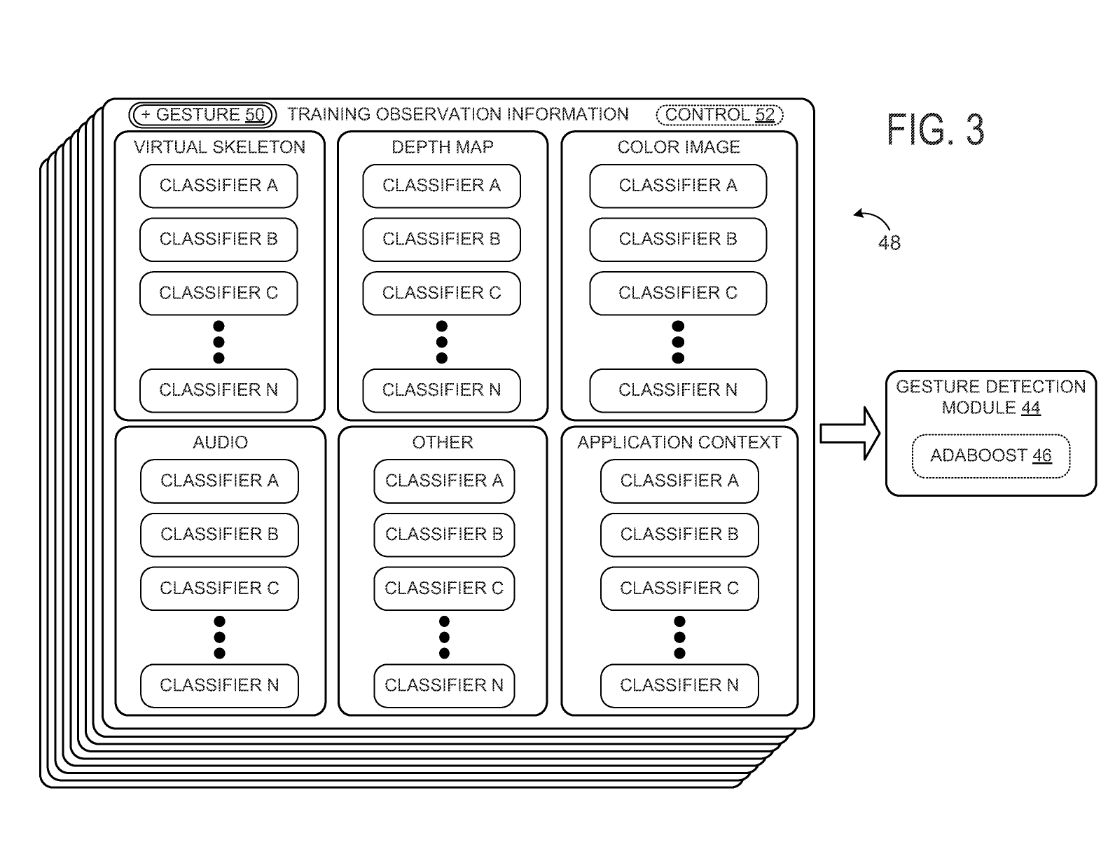

FIG. 3 schematically shows a gesture detection module 44 being trained. Gesture detection module 44 may be trained using a variety of different machine learning techniques without departing from the scope of this disclosure. As a non-limiting example, gesture detection module 44 may be trained with a supervised learning algorithm, such as an Adaptive Boosting (i.e., Adaboost) algorithm 46, which is a type of boosting algorithm. It is to be understood that machine learning techniques in addition to or instead of the Adaboost algorithm may be used. Non-limiting examples of other suitable machine learning techniques include the Rboost algorithm, neural networks, decision trees, k-means clustering, and/or support vector machines. Such algorithms may be used either as offline or online training.

As shown in FIG. 3, as part of the training, the gesture detection module 44 may be provided a very large quantity of training observation information 48. The training observation information 48 may be obtained by having a variety of different human subjects perform different gestures. These subjects perform gestures that are intended to be the particular gesture for which the gesture detection module is being trained (i.e., positive gesture), and other gestures that are different than the gesture for which the gesture detection module is being trained (i.e., negative gesture). These positive and negative training gestures are recorded with one or more sensors (e.g., a depth camera), and the recorded observation information is provided to the gesture detection module 44. As indicated at 50 and 52, the training observation information 48 includes an indication of whether the data represents a positive gesture or a negative gesture, respectively.

It is to be understood that multiclass training may additionally and/or alternatively be performed in which two or more gestures are trained at the same time. As such, a single gesture detection module may be configured to return which gesture has been performed from a number of different possible gestures and/or return a confidence value for each possible gesture for which the module is trained.

This machine learning approach provides a holistic gesture detection system based on training data (e.g., observation information 48) that requires no code changes from detecting one gesture to another. In other words, a gesture detection module can be created for any desired gesture simply by training that gesture detection module with appropriate training observation information. This approach eliminates the need for manually fine tuning a large number of input parameters, thresholds, and weights, and can also compensate for latency in that the machine learning module can learn the point when a human's movements are intended to be a particular gesture, and not just the point when the gesture finishes.

A set of features may be defined on which the machine learning module will learn to recognize complex patterns. As indicated in FIG. 3, one or more features may be defined for a variety of different types of observation training information. Such features may be related to aspects of the virtual skeleton, aspects of the observation information used to derive the virtual skeleton (e.g., depth maps), aspects of a color image, aspects of recorded audio, aspects of the application context (e.g., the current state of a game when the application is performed), or virtually any other observable/recordable information at the time that the gesture is performed. The gesture detection module can be trained to determine if one or more of these features indicate that a human subject has performed a particular gesture.

As a non-limiting example, the velocity of a hand joint is a virtual skeleton feature that may be a strong indicator as to whether a human subject is intending to complete a throw gesture. As another example, the relative position of the hand joint compared to the head joint may be another strong indicator. As still another example, the relative position of the elbow joint compared to the shoulder joint may be another strong indicator. A gesture detection module may be trained to consider virtually any number of these features. By analyzing many different instances of positive gestures and negative gestures, the gesture detection module can use machine learning to determine which features serve as the strongest indicators.

The following are provided as non-limiting examples of possible features. It is to be understood that other features are within the scope of this disclosure.

The vertical body axis angle is an example feature derived from the virtual skeleton. A vertical axis can be defined between a spine joint and a center shoulder joint of the virtual skeleton. An angle can be calculated between this vertical axis and any/all other joints in the virtual skeleton. Any of these angles may serve as features.

The horizontal body axis angle is another example feature derived from the virtual skeleton. A horizontal axis can be defined between a center shoulder joint and either the left or right shoulder joint of the virtual skeleton. An angle can be calculated between this horizontal axis and any/all other joints in the virtual skeleton. Any of these angles may serve as features.

A comparison of an attribute of a first joint of the virtual skeleton and an attribute of a second joint of the virtual skeleton may be used as another example feature derived from the virtual skeleton. For example, a simple subtraction of two joint positions can reveal if one joint is in front of another, above the other, or to the left or right of the other. Such differences can be calculated between any/all other joints in the virtual skeleton. Furthermore, aspects other than joint position can be compared between different joints. Any of these differences or other comparisons may serve as features.

Angular and linear joint speed and velocity are other example features derived from the virtual skeleton. The linear speed and/or velocity of any/all joints may be calculated by dividing the difference in a particular joint's position in two different frames by the elapsed time between those frames. Similarly, the angular speed or velocity may be calculated by comparing the joint angle in two different frames (e.g., angle between shoulder, elbow, and hand in successive frames). Any of these speeds and/or velocities may serve as features.

Angular and linear joint acceleration are other example features derived from the virtual skeleton. The linear acceleration of any/all joints may be calculated by dividing the difference in a particular joint's velocity in two different frames by the elapsed time between those frames. Similarly, the angular acceleration may be calculated by comparing the angular velocity in two different frames. Any of these accelerations may serve as features.

Joint force is another example feature derived from the virtual skeleton. The joint force of any/all joints may be calculated by multiplying a joint acceleration by an estimated mass of a body part corresponding to that joint. Any of these forces may serve as features.

Joint power is another example feature derived from the virtual skeleton. The joint power of any/all joints may be calculated by multiplying a joint force throughout two or more frames by the distance the joint moves during those frames. Any of these powers may serve as features.

Joint attribute (e.g., angle) over key frames is yet another example feature derived from the virtual skeleton. An attribute in space-time can be calculated for the same joint by calculating a plurality (e.g., three) of key frames from a buffer of virtual skeleton data accumulated over time. Key frames may be independent of time and only need be different enough from one another by a predetermined error metric. Any of these attributes over key frames may serve as features.

Bone length and bone length differences over time are yet other example features derived from the virtual skeleton. A bone length can be calculated as the length between two different joints of the virtual skeleton. For each bone between two joints in the virtual skeleton, the change in bone length over time can be calculated. Any of these bone lengths and/or bone length differences may serve as features.

Zero pixel density is an example feature derived from the observation information used to derive the virtual skeleton (i.e., depth map). The zero pixel density refers to the number of pixels that are invalid in the depth map. The zero pixel density for the entire depth map and/or any particular region of the depth map may serve as a feature.

Length of feature circumference is another example feature derived from the depth map. The length of feature circumference refers to the circumference of an area that is needed to fit a body part imaged by the depth image. For example, a hand joint may be modeled by the virtual skeleton and the depth map may be analyzed at the position corresponding to that hand joint. By inferring that the forward most pixels at that location are imaging a human subject's hand, a circle can be constructed in which all such pixels can fit. The size of this circle may indicate if a hand is open or closed, for example. Similar to the length of feature circumference, the area, mean of area, and/or variance of area, from the depth map may be used. The length of feature circumference, area, mean of area, and/or variance of area may serve as features.

A voxel representation of an aspect of a depth image is another example feature derived from the depth map. For example, a voxel representation of the hand including clipping the wrist voxels and floodfill-climbing hand voxels to exclude other body parts may be used. First and second moments of the voxel representation (e.g., eccentricity and moment of inertia) may be used, as may a histogram of distances from a centroid to the voxels, mean and variance of the histogram, difference between buckets, and the absolute value of a bucket. A projection of voxels onto a two dimensional grid which has a binary feature (occupied/not occupied) per cell may also be used.

A contour of a body part image may be used as a feature. For example, a contour of a hand image in camera space can be built, and the following may serve as features for determining if the hand is open or closed: the number of peaks in the contour, amount of deviation from the mean and/or median, extents of the changes between peaks and valleys of the contour, smoothness of the contour, whether or not the contour is symmetric.

Aspects of an edge detection histogram derived from the depth map and/or from a color image may also serve as features.

These and other aspects of the virtual skeleton, depth map, color image, audio, application context, or other aspects of observation information may be analyzed by a trained gesture detection module to determine if a human subject intends to complete a particular gesture.

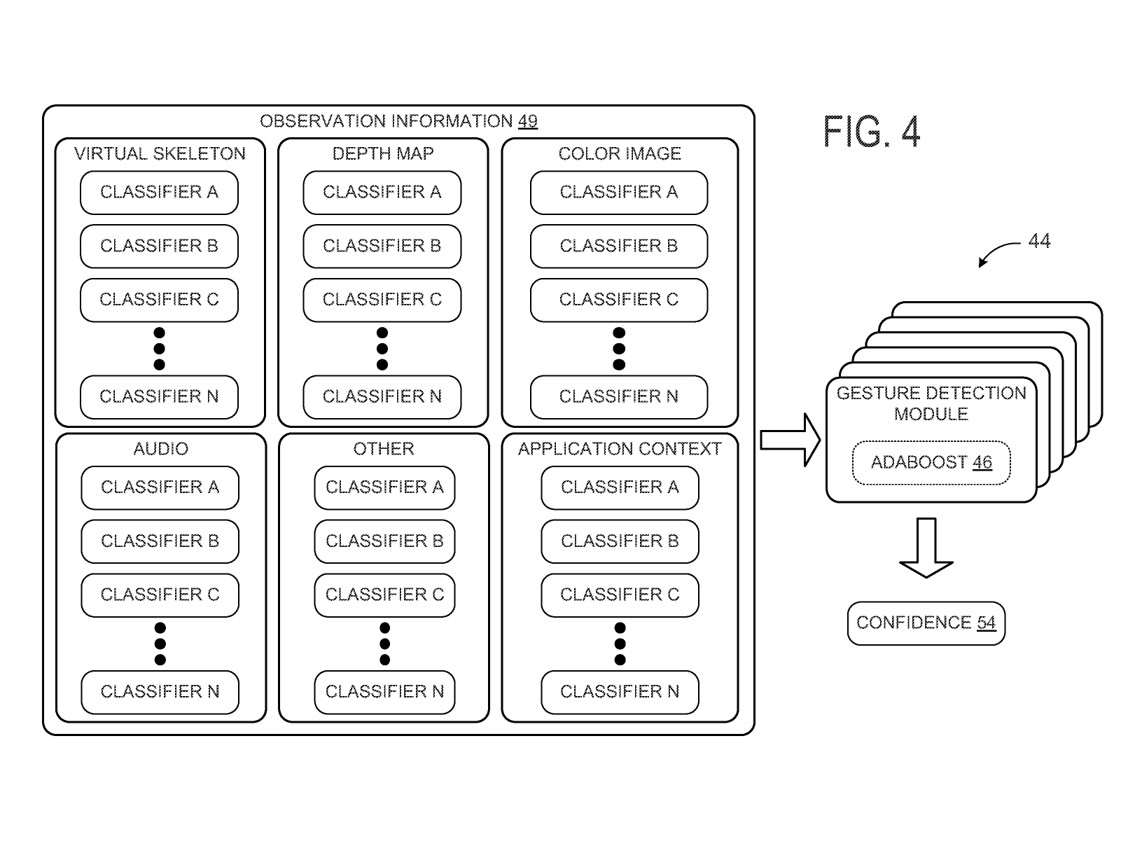

FIG. 4 schematically shows gesture detection module 44 in use after training. For example, the gesture detection module 44 may be a software module executing on computing system 10 of FIG. 1. Prior to use, gesture detection module 44 has been provided a large amount of training observation information, as described with reference to FIG. 3.

Via the process of machine learning, the gesture detection module 44 is trained to receive new sets of observation information 49 in real-time as a human subject performs gestures (e.g., to control an application, as shown in FIG. 1). For example, the gesture detection module may receive a runtime instance of one or more features of the virtual skeleton. The gesture detection module 44 is configured to analyze the new set of observation information and output a confidence 54 that the human subject has performed a particular gesture for which that gesture detection module tests. In some embodiments, the confidence may be binary—e.g., yes (gesture performed) or no (gesture not performed). In other embodiments, the confidence may be a relative confidence—e.g., anywhere in the range from 0% confident gesture performed to 100% confident gesture performed.

As shown in FIG. 4, the same observation information may be provided to a plurality of different gesture detection modules, each of which is trained via machine learning to test for a different gesture. In this way, a gesture the human subject intends to perform may be determined by virtue of the highest relative confidence output from the various gesture detection modules. In response to determining that a particular gesture has been performed, any suitable action may be taken. As a non-limiting example, if a cast fireball gesture is detection, a player character of a game application may throw a fireball, as shown in FIG. 1.

As introduced above, a gesture detection module may utilize virtually any machine learning algorithm without departing from the scope of this disclosure. The Adaboost boosting algorithm is a non-limiting example of one such algorithm. The following is a pseudo code representation of the Adaboost boosting algorithm:

Input
N labeled training examples in training set S
   S={(xₙ, yₙ)}ₙ₌₁^{N}, xεX, yεY, Y={−1,+1}
   Example data x comes from observation information (e.g., virtual skeleton, depth, etc.)
   Positive examples labeled with +1
   Negative examples labeled with −1

For t=1, 2, . . . T
Weak learner L selects weak classifier hₜ from pool of weak classifiers
   Select the best weak classifier, i.e., the one with the lowest error
   Pool of weak classifier generated from multiple features, (e.g., joint velocity)
Calculate confidence at for selected hₜ

Example formula:

$$α = 0.5 \times log ( \frac{1 - MinError}{MinError} )$$

Emphasize training examples that do not agree with hₜ

Output strong classifier H

Example formula:

H(x)=sign(Σₜ₌₁^{T}αₜhₜ(x))

As another example, an Rboost algorithm may be used. In some cases, using RBoost with AdaBoost may result in a more compact representation that improves real time performance and reduces storage requirements. In particular, the regularized loss minimization problem may be solved:

L(\vec{a})=Σᵢ₌₁exp(−yᵢΣⱼ₌₁^{|H|}αⱼhⱼ(xᵢ)) such that Σⱼ₌₁^{|H|}|αⱼ|≦R
where x are instances of the training data and y are corresponding labels, m is the number of instances of training data and H is a set of classifiers h.
   Starting values for the classifier weights α may be obtained using AdaBoost. The following is a pseudo code representation of the Rboost boosting algorithm:

| | |
|---|---|
| 1: | \vec{α} ← \vec{α}₀ |
| 2: | wᵢ = exp(−yᵢΣⱼ₋₁^{\|H\|}αⱼhⱼ(xᵢ) |
| 3: | $w ← \frac{w}{‖ w ‖ 1}$ |
| 4: | for t = 1 to T do |
| 5: | hₖ = argmaxⱼedge(hⱼ,w) |
| 6: | hₗ = argmin_{j:α}_{ⱼ}_{>0}edge(hⱼ,w) |
| 7: | $ɛ = min ( {2}_{al} , \frac{1}{2} ln \frac{P ( {yh}_{k} ( x ) > {yh}_{l} ( x ) )}{P ( {yh}_{k} ( x ) < {yh}_{l} ( x ) )} )$ |
| 8: | ${a}_{k} ← {a}_{k} + \frac{ɛ}{2}$ |
| | ${a}_{k} ← {a}_{k} - \frac{ɛ}{2}$ |
| 9: | ${w}_{i} ← \{ \begin{matrix}{w}_{i} {e}^{ɛ} & if {y}_{i} {h}_{k} ( {x}_{i} ) < {y}_{i} {h}_{l} ( {x}_{i} ) \\ {w}_{i} {e}^{- ɛ} & if {y}_{i} {h}_{k} ( {x}_{i} ) > {y}_{i} {h}_{l} ( {x}_{i} ) \\ {w}_{i} & if {y}_{i} {h}_{k} ( {x}_{i} ) = {y}_{i} {h}_{l} ( {x}_{i} )\end{matrix}$ |
| 10. | $w ← \frac{w}{‖ w ‖ 1}$ |
| 11: | end for |
| 12: | Result: h_{c}(x) = sign(Σⱼ₌₁^{\|H\|}αⱼhⱼ(x)) |

The above described methodologies have primarily focused on offline machine learning techniques. It is to be understood that online machine learning may be used. As an example, cloud computing could be used to improve existing trained gestures with specific training data of a new subject.

In some embodiments, the above described methods and processes may be tied to a computing system including one or more computers. In particular, the methods and processes described herein may be implemented as a computer application, computer service, computer API, computer library, and/or other computer program product.

FIG. 5 schematically shows a non-limiting computing system 56 that may perform one or more of the above described methods and processes. Computing system 56 is shown in simplified form. It is to be understood that virtually any computer architecture may be used without departing from the scope of this disclosure. In different embodiments, computing system 56 may take the form of a mainframe computer, server computer, desktop computer, laptop computer, tablet computer, home entertainment computer, network computing device, mobile computing device, mobile communication device, gaming device, etc.

Computing system 56 includes a logic subsystem 58, a data-holding subsystem 60, and a sensor subsystem 62. Computing system 56 may optionally include a display subsystem 64, communication subsystem 66, and/or other components not shown in FIG. 5. Computing system 56 may also optionally include user input devices such as keyboards, mice, game controllers, cameras, microphones, and/or touch screens, for example.

Logic subsystem 58 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 60 may include one or more physical, non-transitory, devices configured to hold data and/or instructions executable by the logic subsystem to implement the herein described methods and processes. When such methods and processes are implemented, the state of data-holding subsystem 60 may be transformed (e.g., to hold different data).

Data-holding subsystem 60 may include removable media and/or built-in devices. Data-holding subsystem 60 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 60 may include devices with one or more of the following characteristics: volatile, nonvolatile, dynamic, static, read/write, read-only, random access, sequential access, location addressable, file addressable, and content addressable. In some embodiments, logic subsystem 58 and data-holding subsystem 60 may be integrated into one or more common devices, such as an application specific integrated circuit or a system on a chip.

FIG. 5 also shows an aspect of the data-holding subsystem in the form of removable computer-readable storage media 68, which may be used to store and/or transfer data and/or instructions executable to implement the herein described methods and processes. Removable computer-readable storage media 68 may take the form of CDs, DVDs, HD-DVDs, Blu-Ray Discs, EEPROMs, and/or floppy disks, among others.

It is to be appreciated that data-holding subsystem 60 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of computing system 56 that is implemented to perform one or more particular functions. In some cases, such a module, program, or engine may be instantiated via logic subsystem 58 executing instructions held by data-holding subsystem 60. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

Sensor subsystem 62 may include one or more sensors configured to sense one or more human subjects, as described above. For example, the sensor subsystem 62 may comprise one or more image sensors, motion sensors such as accelerometers, touch pads, touch screens, and/or any other suitable sensors. Therefore, sensor subsystem 62 may be configured to provide observation information to logic subsystem 58, for example. As described above, observation information such as image data, motion sensor data, and/or any other suitable sensor data may be used to perform such tasks as determining a particular gesture performed by the one or more human subjects.

In some embodiments, sensor subsystem 62 may include a depth camera 70 (e.g., depth camera 22A of FIG. 1). Depth camera 70 may include left and right cameras of a stereoscopic vision system, for example. Time-resolved images from both cameras may be registered to each other and combined to yield depth-resolved video.

In other embodiments, depth camera 70 may be a structured light depth camera configured to project a structured infrared illumination comprising numerous, discrete features (e.g., lines or dots). Depth camera 70 may be configured to image the structured illumination reflected from a scene onto which the structured illumination is projected. Based on the spacings between adjacent features in the various regions of the imaged scene, a depth image of the scene may be constructed.

In other embodiments, depth camera 70 may be a time-of-flight camera configured to project a pulsed infrared illumination onto the scene. The depth camera may include two cameras configured to detect the pulsed illumination reflected from the scene. Both cameras may include an electronic shutter synchronized to the pulsed illumination, but the integration times for the cameras may differ, such that a pixel-resolved time-of-flight of the pulsed illumination, from the source to the scene and then to the cameras, is discernable from the relative amounts of light received in corresponding pixels of the two cameras.

In some embodiments, sensor subsystem 62 may include a visible light camera 72 (e.g., visible light camera 22B of FIG. 1). Virtually any type of digital camera technology may be used without departing from the scope of this disclosure. As a non-limiting example, visible light camera 72 may include a charge coupled device image sensor.

When included, display subsystem 64 may be used to present a visual representation of data held by data-holding subsystem 60. As the herein described methods and processes change the data held by the data-holding subsystem, and thus transform the state of the data-holding subsystem, the state of display subsystem 64 may likewise be transformed to visually represent changes in the underlying data. Display subsystem 64 may include one or more display devices utilizing virtually any type of technology. Such display devices may be combined with logic subsystem 58 and/or data-holding subsystem 60 in a shared enclosure, or such display devices may be peripheral display devices.

When included, communication subsystem 66 may be configured to communicatively couple computing system 56 with one or more other computing devices. Communication subsystem 66 may include wired and/or wireless communication devices compatible with one or more different communication protocols. As non-limiting examples, the communication subsystem may be configured for communication via a wireless telephone network, a wireless local area network, a wired local area network, a wireless wide area network, a wired wide area network, etc. In some embodiments, the communication subsystem may allow computing system 56 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system, comprising:
a sensor input to receive observation information from one or more sensors;
a skeletal modeling module to derive a virtual skeleton from the observation information received from the one or more sensors; and
a gesture detection module trained via machine learning to determine if at least one or more features of the virtual skeleton collectively indicate a human subject modeled by the virtual skeleton has performed a particular gesture.

2. The computing system of claim 1, wherein the one or more sensors includes a depth camera and the observation information includes a depth image.

3. The computing system of claim 2, wherein the one or more sensors includes a visible light camera and the observation information includes a color image.

4. The computing system of claim 1, wherein the gesture detection module is trained with a supervised learning algorithm.

5. The computing system of claim 4, wherein the supervised learning algorithm is a boosting algorithm.

6. The computing system of claim 5, wherein the boosting algorithm is an Adaboost algorithm.

7. The computing system of claim 1, wherein the gesture detection module is further trained via machine learning to determine if one or more features of the observation information used to derive the virtual skeleton indicate the human subject has performed the particular gesture.

8. The computing system of claim 1, wherein the gesture detection module is further trained via machine learning to determine if one or more features of an application context indicate the human subject has performed the particular gesture.

9. The computing system of claim 1, wherein the gesture detection module is configured to output a confidence that the particular gesture has been performed by the human subject.

10. The computing system of claim 1, wherein the one or more features include a vertical body axis angle.

11. The computing system of claim 1, wherein the one or more features include a horizontal body axis angle.

12. The computing system of claim 1, wherein the one or more features include a comparison of an attribute of a first joint of the virtual skeleton and an attribute of a second joint of the virtual skeleton.

13. The computing system of claim 1, wherein the one or more features include a joint speed.

14. The computing system of claim 1, wherein the one or more features include a joint velocity.

15. The computing system of claim 1, wherein the one or more features include a joint acceleration.

16. The computing system of claim 1, wherein the one or more features include a joint force.

17. The computing system of claim 1, wherein the one or more features include a joint angle over key frames.

18. A data-holding subsystem holding instructions executable by a logic subsystem to:
receive one or more runtime instances of features of a gesture model;
analyze the one or more runtime instances of features of the gesture model with a machine learning module previously trained with training instances of one or more features of the gesture model; and
output a confidence that a human subject modeled by the gesture model has performed a particular gesture.

19. A computing system, comprising:
a depth camera input to receive depth images from a depth camera;
a skeletal modeling module to derive a virtual skeleton from the depth images received from the depth camera; and
a gesture detection module trained via machine learning to determine if at least one or more features of the virtual skeleton collectively indicate a human subject modeled by the virtual skeleton has performed a particular gesture.

20. The computing system of claim 19, wherein the gesture detection module is further trained via machine learning to determine if one or more features of the depth images indicate the human subject has performed the particular gesture.
